(19) United States
(12) Patent Application Publication
(10) Pub. No.: US 2008/0197047 A1
(43) Pub. Date: Aug. 21, 2008

(54) Pedeatric medicine dosage cup, tray and fabrication method

(75) Inventors: Jill Malkin, New York, NY (US); Geoffrey J. Addeo, New York, NY (US); James Guido, Brooklyn, NY (US)

Correspondence Address: EPSTEIN DRANGEL BAZERMAN & JAMES, LLP, 60 EAST 42ND STREET, SUITE 820, NEW YORK, NY, 10165, US

(73) Assignee: KidKupz LLC

(21) Appl. No.: 12/070,144

(22) Filed: Feb. 14, 2008

Related U.S. Application Data
(60) Provisional application No. 60/901,925, filed on Feb. 15, 2007.
(60) Provisional application No. 60/923,428, filed on Apr. 13, 2007.

(51) Int. Cl. A61J 1/16; A61J 1/05; B05D 1/18; B05D 3/00

(52) U.S. Cl. 206/563; 604/403; 427/430.1; 427/398.1

(57) ABSTRACT

A cup is provided for containing a liquid medicine. The cup includes a wall with a candy coated rim portion. The coating includes a mixture of sugar, water and agar, and a layer of flavored and/or colored powdered sugar. A plurality of inwardly extending spacer ribs are spaced around the wall of the cup. The spacer ribs preferably have a generally triangular shape. The cup is made by orienting the cup in an upside down position; dipping the cup into a heated liquid mixture of sugar, water and agar to coat the rim portion of the cup; removing the cup; allowing the liquid on the rim portion to partially cool to a tacky consistency; applying powdered sugar to the tacky liquid, and allowing the coating to completely cool. A tray is provided for holding a plurality of cups. The tray includes a bottom with a plurality of spaced, substantially upside down cup-shaped bosses projecting upwardly from the tray bottom. Each of the bosses includes a reinforced side wall. The tray has a reinforced peripheral wall.

### CROSS-REFERENCE TO RELATED APPLICATIONS

Applicants claim priority on Provisional Patent Application Ser. No. 60/901,925, filed Feb. 15, 2007 and on Provisional Patent Application Ser. No. 60/923,428, filed Apr. 13, 2007.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to a cup for the delivery of a medicine dosage, a tray for holding a plurality of such cups and to a method of fabricating the cups.

2. Description of Prior Art Including Information Disclosed Under 37 CFR 1.97 and 1.98

Any person who has is involved in child care or is in a medical profession that involves children knows that getting children to take medicine orally can be a struggle because medicines generally do not taste very good. In order to overcome that problem, we have invented a cup useful for giving medicine to children that masks the bad taste of the medicine. We have also developed a method for fabricating the pediatric medicine dosage cups, mounting the cups on a tray and packaging the tray.

As far as applicants are aware, there is no prior art relevant to our cup for the delivery of a medicine dosage, the tray for holding the cups and/or the method for fabricating the cups and packaging the tray with the cups mounted on it.

### BRIEF SUMMARY OF THE INVENTION

In accordance with one aspect of the present invention, a cup is provided for containing a liquid. The cup includes a wall with a rim portion. A coating is situated on the rim portion. The coating includes a mixture of sugar, water and agar, and a layer of powdered sugar.

The cup is intended for use with a liquid such as a medication dosage.

The coating preferably includes 70-80% to sugar, 15 to 20% water and 5 to 12% agar.

The powdered sugar layer preferably includes flavored and/or colored sugar.

A plurality of inwardly extending spacer ribs are provided around the wall of the cup. The spacer ribs preferably have a generally triangular shape.

In accordance with another aspect of the present invention, a method is provided for making a cup with a coated rim portion. The method includes the steps of: orienting the cup in an upside down position; dipping the cup into a heated liquid mixture of sugar, water and agar to coat the rim portion of the cup; removing the cup; allowing the liquid on the rim portion to partially cool to a tacky consistency; applying powdered sugar to the tacky liquid, and allowing the coating to completely cool.

The method also includes the steps of placing the cup on a tray holder and packaging the tray holder with the cup mounted thereon.

The method further includes the step of forming the cup with inwardly extending spacer ribs.

In accordance with another aspect of the present invention, a method is provided for making a plurality of cups. Each of the cups has a coated rim portion. The method includes the steps of: orienting a plurality of cups in an upside down position; simultaneously dipping the cups into a heated liquid mixture of sugar, water and agar to coat the rim portions of the cups; removing the cups; allowing the liquid on the rim portions to partially cool to a tacky consistency; applying powdered sugar to the tacky liquid, and allowing the coating to completely cool.

The method further includes the steps of placing the cups on a tray holder and packaging the tray holder with the cups mounted thereon.

The method further includes the step of forming the cups with inwardly extending spacer ribs.

In accordance with another aspect of the present invention, a tray is provided for holding a plurality of cups. The tray includes a bottom. A plurality of spaced, substantially upside down cup-shaped bosses project upwardly from the tray bottom. Each of the bosses includes a side wall. Each of the side walls includes a plurality of inwardly extending, circumferentially spaced structural re-enforcing ribs.

The tray also includes an upstanding peripheral wall surrounding and spaced from the bosses. The upstanding peripheral wall includes spaced, structural re-enforcing ribs.

The tray is intended for holding cups having a wall with two or more inwardly directed spacing ribs.

It is, therefore, a prime object of the present invention to provide a cup for the delivery of pediatric medicine dosage.

It is another object of the present invention to provide a tray for holding a plurality of pediatric medicine dosage cups.

It is another object of the present invention to provide a method for fabricating pediatric medicine dosage cups.

### BRIEF DESCRIPTION OF THE SEVERAL VIEWS OF DRAWINGS

To these and to such other objects that may hereinafter appears, the present invention relates to a pediatric medicine dosage cup, a tray for holding the cups and a method for fabricating the cups as described in detail in the following specification and recited in the annexed claims, taken together with the accompanying drawings, in which like numerals refer to like parts and in which:

FIG. 1 is a perspective view of the pediatric medicine dosage cup of the present invention;

FIG. 2 is a side cross-sectional view of the cup of FIG. 1 showing the spacer ribs;

FIG. 3 is a perspective view of a tray for holding a plurality of cups of the type depicted in FIGS. 1 and 2;

FIG. 4 is a side cross-sectional view of the tray of FIG. 3, showing the tray without cups mounted on it;

FIG. 5 is a side cross-sectional view of the tray of FIG. 3, showing the tray with a cup mounted on it; and

FIG. 6 is a flow chart of the cup fabrication, mounting and packaging process.

### DETAILED DESCRIPTION OF THE INVENTION

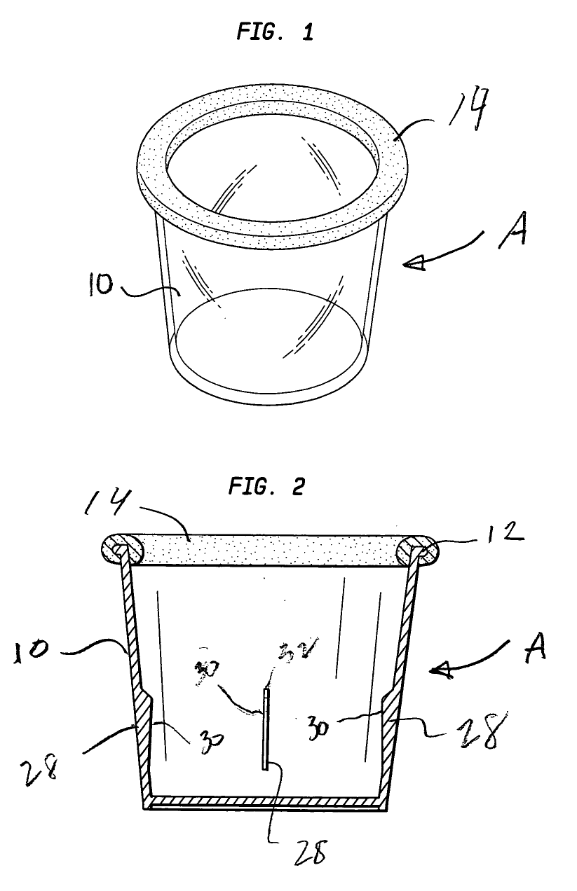

FIGS. 1 and 2 depict the cup of the present invention, generally designated A. Cup A is a dosage cup intended to be used for the disbursement of pediatric medications. The cup includes a wall 10 with a rim portion 12. Rim portion 12 has a candy coating 14 formed on it. The candy coating 14 is intended to mask the taste of the medicine to make same more palatable for a child.

Preferably, cup A is formed of opaque or translucent plastic. It can be fabricated by any conventional cup forming process. Preferably, the cup is sized to hold a 3 teaspoon dosage of medicine. However, other cup sizes may also be utilized.

Coating 14 is made up of sugar, natural colors, natural flavors and agar. Preferably, the ingredients of the coating are in the following proportions: 70 to 80% sugar, 15 to 20% water and 5 to 12% agar.

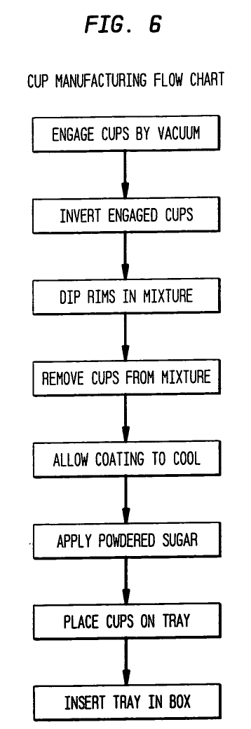

The cups may be fabricated using a continuous manufacturing process, as set forth on the flow chart of FIG. 6. The cups are formed with inwardly extending spacer ribs. The cups are placed right side up on a multi cup magazine on a conveyor. The magazine accommodates cups in multiples of the number of cups that will be held by a tray, in this example, three. The magazine includes a stainless steel carrier and a stainless steel frame such that it meets all USDA/FDA standards.

The magazine is engaged by a vacuum suction apparatus. The vacuum suction apparatus inverts the magazine such that the cups are upside down and moves the magazine such that the inverted cups are positioned over the open top of a tank containing a liquid sugar/water/agar mixture that is heated, preferably to a temperature in the range of between 140 to 160 degrees F. The magazine with the inverted cups is lowered into the heated syrup mixture such that the rim portions of the cups are simultaneously submerged in the liquid.

The magazine is removed from the tank and allowed to partially cool, preferably form 5 to 10 seconds, such that the liquid on the rim portions of the cups become tacky. Flavored and/or colored powdered sugar is applied to the still warm, now tacky liquid on the rim portions of the cups to complete the coating. That can be done by blowing the sugar onto the rim portions or by dipping the rim portions into the sugar. The cups are again allowed to cool, preferably for 30 to 40 seconds, until the coating is completely cool and solid.

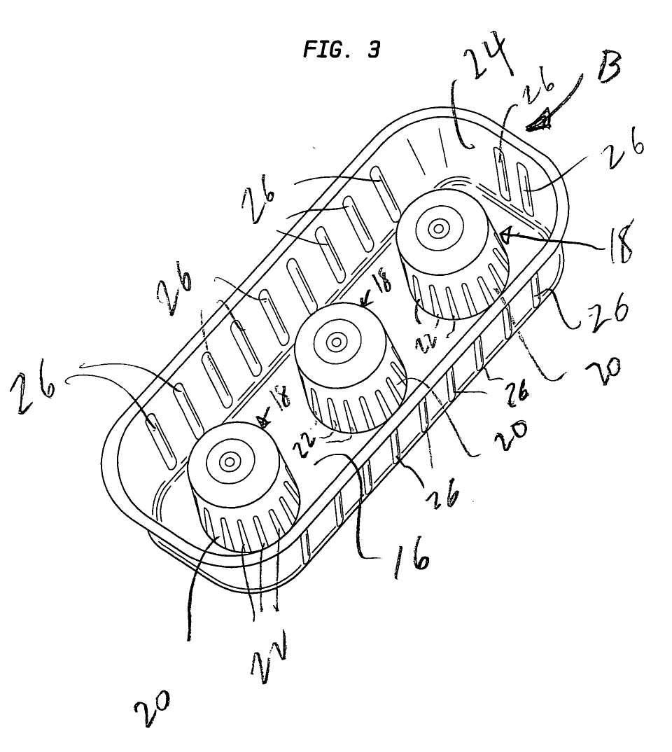

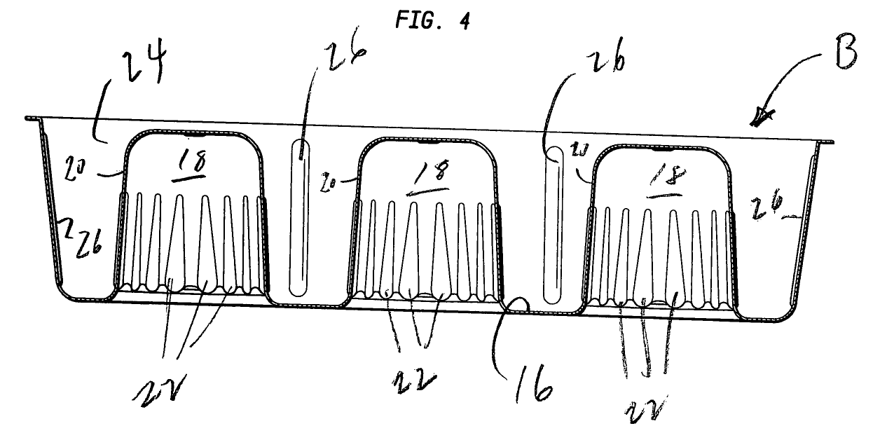

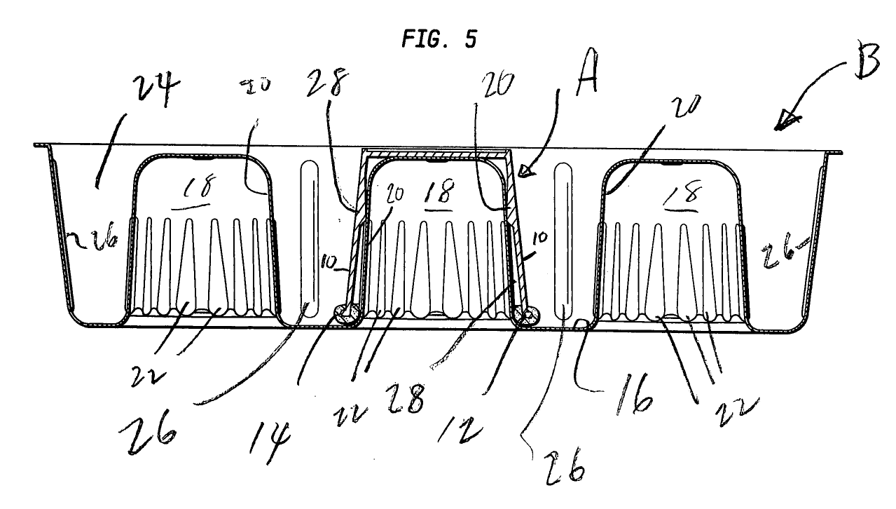

Once completely cooled, the cups are placed on a conveyor which supports side-by-side trays, generally designated B, of the type shown in FIGS. 3, 4 and 5. One tray B is provided for every three cups engaged by the magazine. The trays with the cups mounted thereon are then packaged in a box. Prior to placing the trays in the box, the individual trays may be wrapped in plastic such that they remain sanitary.

As seen in FIGS. 3, 4 and 5, tray B is provided to hold a plurality of cups A. The version of tray B depicted in the figures is intended to hold three cups A. However, trays with similar structure for holding different numbers of cups could be used.

Each tray B consists of a bottom surface 16. A plurality (in this case, three) of spaced bosses 18 project upwardly from the central portion of the bottom surface 16 of the tray. Each of the bosses 18 has the general shape of an inverted cup but is slightly smaller than a cup such that an inverted cup A can be received over the boss the side wall 20 of each boss includes a plurality of inwardly extending; circumferentially spaced re-enforcing ribs 22 that increase the structural rigidity of the boss. Each rib 22 extends along the boss wall from the bottom surface of the tray upwardly toward the top of the boss and tapers to a point at the top most end.

The tray also includes an upstanding peripheral wall 24 surrounding and spaced from the bosses 18. Wall 24 also includes spaced re-enforcing ribs 26 which serve to increase the structural rigidity of the wall. Preferably, ribs 26 have substantially uniform widths.

Referring again to FIG. 2, which is a cross-sectional view of cup A, visible in that figure are a plurality of spacer ribs 28 which extend inwardly from the interior surface of wall 10 of the cup. Ribs 28 are spaced from each other around the interior surface of wall 10. Ribs 28 have two rib portions. The ribs are shaped such that in the first rib portion 30 the width of the rib increases as the distance from the bottom of the cup increases. In a second rib portion 32, which proximate the top of the rib, the width of the rib rapidly decreases. Accordingly, the rib has a generally triangular shape when viewed from the side.

As described above, tray B is designed to hold a number of cups A. Each cup is placed over a different one of the bosses 18 of the tray. FIG. 5 shows one cup A situated over the central boss 18 on the tray. When a cup is mounted on a boss, the edge of first rib portion 30 of each of the spacing ribs 28 of the cup abuts the exterior wall 20 of the boss so as to space the interior wall of the cup a short distance from the exterior wall of the boss. Ribs 28 insure that the cups can be easy removed from the bosses without dislodging or damaging the coating 14 situated on the cup rim portion.

It will now be appreciated that the present invention relates to a cup for the delivery of pediatric medicine dosage that has a candy coated rim to mask the taste of the medicine to make the medicine more palatable to a child. It also relates to tray for holding a plurality of cups which has structurally re-enforced bosses and a peripheral wall. Spacer ribs on the interior of the cups insure that the cups may be mounted over and removed from the tray bosses without damaging the candy coated rim portions of the cups. Further, a method for fabricating the pediatric medicine dosage cups is provided.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

We claim:

1. A cup for containing a liquid comprising a wall with a rim portion and a coating on said rim portion, said coating comprising a sugar, water and agar mixture, and a layer of powdered sugar.

2. The cup of claim 1 wherein said liquid comprises medicine.

3. The cup of claim 1 wherein said coating comprises 70-70% to sugar, 15 to 20% water and 5 to 12% agar.

4. The cup of claim 1 wherein said powdered sugar comprises flavored sugar.

5. The cup of claim 1 wherein said powdered sugar comprises colored sugar.

6. The cup of claim 1 further comprising an inwardly extending spacer rib.

7. The cup of claim 1 further comprising a plurality of spaced, inwardly extending spacer ribs.

8. The cup of claim 6 wherein said rib has a generally triangular shape.

9. A method of fabricating a cup with a coated rim portion comprising the steps of:
orienting the cup in an upside down position;
dipping the cup into a heated liquid mixture of sugar, water and agar to coat the rim portion thereof;
removing the cup;
allowing the liquid on the rim portion to partially cool to a tacky consistency;
applying powdered sugar to the tacky liquid; and
allowing the coating to completely cool.

10. The method of claim 9 further comprising the step of placing the cup on a tray holder.

11. The method of claim 10 further comprising the step of packaging the tray holder.

12. The method of claim 9 further comprising the step of forming the cup with inwardly extending spacer ribs.

13. A method of making a plurality of cups, each of the cups having a coated rim portion, comprising the steps of:
orienting the cups in an upside down position;
simultaneously dipping the cups into a heated liquid mixture of sugar, water and agar to coat the rim portions thereof;
removing the cups;
allowing the liquid on the rim portions to partially cool to a tacky consistency;
applying powdered sugar to the tacky liquid; and
allowing the coating to completely cool.

14. The method of claim 13 further comprising the step of placing the cups on a tray holder.

15. The method of claim 14 further comprising the step of packaging the tray hold with the cups mounted thereon.

16. The method of claim 13 further comprising the step of forming the cups with inwardly extending spacer ribs.

17. A tray for holding a plurality of cups comprising a bottom, a plurality of substantially upside down, generally cup-shaped bosses projecting upwardly from said bottom, each of said bosses comprising a side wall, each of said side walls comprising a plurality of circumferentially spaced structurally re-enforcing ribs.

18. The tray holder of claim 17 further comprising a substantially upstanding peripheral wall surrounding and spaced from said bosses, said upstanding peripheral wall comprising inwardly directed, spaced, structurally re-enforcing ribs.

19. The tray holder of claim 17 for use with a cup comprising a wall with an interior surface having two or more inwardly directed spacing ribs.

20. The tray holder of claim 17 wherein the cups have candy coated rim portions.
